(19) United States
(12) Patent Application Publication
(10) Pub. No.: US 2008/0193672 A1
(43) Pub. Date: Aug. 14, 2008

(54) METHOD AND APPARATUS FOR FORMING PATTERNS, AND LIQUID DRYER

(75) Inventor: Hirotsuna MIURA, Fujimi (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/969,997

(22) Filed: Jan. 7, 2008

(30) Foreign Application Priority Data
Feb. 13, 2007 (JP) 2007-032514

(51) Int. Cl. B05D 3/00; B05B 5/025

(52) U.S. Cl. 427/555; 118/621

(57) ABSTRACT

A pattern formation method includes placing a liquid containing a pattern formation material on a substrate and irradiating a plurality of laser beams to the liquid from different directions to dry the liquid so as to form a pattern made of the pattern formation material.

### BACKGROUND

1. Technical Field

The present invention relates to a method and an apparatus for forming a pattern and to a liquid dryer.

2. Related Art

Recently, there have been known circuit modules, in which electronic components such as semiconductor elements are mounted on a multilayer low-temperature co-fired ceramic (LTCC) substrate made of glass ceramic. The multilayer LTCC substrate can be formed by firing laminated green sheets at a low temperature of 900° C. or lower. Thus, internal wirings can be made of a metal having a low melting point, such as gold or silver, thereby enabling reduction of the resistance of the internal wirings.

In a process for manufacturing such a multilayer LTCC substrate, a metal paste or a metallic ink is used to draw a wiring pattern on each of the green sheets before lamination. As an example of the drawing method, JP-A-2005-57139 discloses a so-called inkjet method for discharging minute liquid droplets of a metallic ink. In the inkjet method, the minute liquid droplets are made to join together to draw a wiring pattern. Thus, the inkjet method can quickly respond to changes in the design of the internal wirings (e.g. a density increase of the internal wirings or reductions of a wiring width and a wiring pitch).

Meanwhile, depending on a surface condition of the green sheet and a surface tension thereof, liquid droplets that landed on the green sheet change their size, shape, or the like as time passes. A timing in which the liquid droplets changeable in size and shape are dried determines a size of the wiring pattern. For example, when 100 milliseconds pass after a liquid droplet of a metallic ink having an outer diameter of 30 μm lands on a lyophilic green sheet, the outer diameter thereof expands to 70 μm. After 200 milliseconds, the outer diameter thereof becomes larger to be 100 μm. Thus, when the timing where the liquid droplets are dried varies within a range from “after 100 milliseconds” to “after 200 milliseconds”, the line width of a corresponding wiring pattern varies within a range from approximately 70 to 100 μm.

Accordingly, as a liquid droplet drying method, in order to suppress such a pattern size variation, there is proposed a laser drying process, in which a laser beam is irradiated to liquid droplets on a green sheet. The laser drying process enables drying of the liquid droplets to be performed only on a laser-beam irradiated region, so that a high-precision drying process can be accomplished.

In the drying process of the liquid droplets by laser irradiation, however, a density distribution of metal microparticles dispersed in the individual liquid droplets changes. As a result, a “rim rising” phenomenon occurs at edges of the pattern, where the edges thereof rise higher than a center part thereof. Thus, it is difficult to flatten a wiring pattern composed of the metal microparticles after drying.

Additionally, due to water repellency of a substrate where the droplets land or due to the surface tension of the liquid droplets, the landed droplets tend to pull each other and easily degenerate. There is, thus, a limitation in drying the liquid droplets precisely enough to form a desired pattern.

### SUMMARY

The present invention has been accomplished to solve the above problems. An advantage of the present invention is to provide a method and an apparatus for forming a pattern, in which laser beam irradiation controls the position of a liquid to dry the liquid at a desired position so as to form a pattern made of a pattern formation material with high definition and high precision. Another advantage of the invention is to provide a liquid dryer.

A pattern formation method according to a first aspect of the invention includes placing a liquid containing a pattern formation material on a substrate and irradiating a plurality of laser beams to the liquid from different directions to dry the liquid so as to form a pattern made of the pattern formation material.

In the pattern formation method according to the first aspect, the liquid placed on the substrate is moved by the laser beams irradiated from the different directions, so that the laser beams control the position of the liquid. In this manner, the liquid can be dried at a desired position on the substrate, thus enabling formation of a pattern made of the pattern formation material with high definition and high precision.

In the above pattern formation method, preferably, the laser beams are irradiated to the liquid to control the position of the liquid, the laser beams being irradiated in directions and intensity distributions in which the laser beams mutually approximately offset at least a momentum of the liquid in a movable direction.

In the above method, each of the laser beams is irradiated to the liquid such that the liquid is retained at a predetermined position, and the liquid is soon dried by the laser beams.

A pattern formation method according to a second aspect of the invention includes placing a liquid containing a pattern formation material on a substrate and irradiating a first laser beam for drying the liquid and a second laser beam for controlling a position of the liquid so as to form a pattern made of the pattern formation material on the substrate.

In the pattern formation method according to the second aspect, the second laser beam freely changes the position of the liquid placed on the substrate and the first laser beam dries the liquid. As a result, the liquid on the substrate can be formed into a desired pattern by the second laser beam and can be surely dried in the desired pattern.

In the method according to the second aspect, preferably, the first laser beam dries the liquid after the second laser beam controls the position of the liquid such that the liquid is located at a predetermined position.

In this method, after the second laser beam adjusts the position of the liquid in advance, the first laser beam dries the liquid. As a result, even if the position thereof on the substrate is deviated, the second laser beam corrects the deviation, so that the liquid thereon can be formed into a desired pattern to be surely dried.

In the method according to the second aspect, preferably, the first laser beam dries the liquid while the second laser beam is controlling the position of the liquid such that the liquid is moved to a predetermined position.

In this method, the liquid is dried by the first laser beam while being moved to the predetermined position by the second laser beam. Accordingly, the liquid on the substrate is dried while being formed into a desired pattern.

In the pattern formation method according to the second aspect, preferably, the first laser beam dries the liquid while the second laser beam is retaining the liquid at a predetermined position.

In this method, in the state where the liquid is retained at the predetermined position by the second laser beam, the liquid is dried by the first laser beam. Accordingly, the liquid can be uniformly and surely dried, so that a desired flat pattern made of the pattern formation material can be formed on the substrate.

In the pattern formation method according to the second aspect, preferably, the first laser beam has a wavelength with a high rate of absorption into the liquid, whereas the second laser beam has a wavelength with a low rate of absorption thereinto.

In this method, since the first laser beam is highly absorbed by the liquid, motion energy of photons is concentrated on the pattern formation material at a surface portion of the liquid. Then, there occur collisions among microparticles of the pattern formation material. The collisions among them generate heat, which dries the liquid. Meanwhile, since the second laser beam is poorly absorbed by the liquid, the motion energy of photons is transmitted to the microparticles of the pattern formation material of the entire inside of the liquid. The individual microparticles thereof cannot obtain a large amount of the motion energy occurring in a process where heat is generated by the collisions among the microparticles thereof. Instead, the microparticles thereof perform a motion for causing a translational motion of the liquid in a direction along a proceeding direction of the second laser beam. Accordingly, the second laser beam can freely control the position of the liquid by changing its irradiation direction and power intensity.

A pattern formation apparatus according to a third aspect of the invention includes a liquid droplet discharging head for discharging a liquid containing a pattern formation material, a substrate for receiving a droplet of the liquid discharged from the head, a first laser output unit for emitting a first laser beam to dry the liquid droplet on the substrate, a second laser output unit for emitting a second laser beam to move the liquid droplet thereon, a first irradiation unit for irradiating the first laser beam emitted from the first laser output unit to the liquid droplet thereon, and a second irradiation unit for irradiating the second laser beam emitted from the second laser output unit to the liquid droplet thereon from a direction different from an irradiation direction of the first laser beam.

In the pattern formation apparatus according to the third aspect, the first laser beam is irradiated to the liquid through the first irradiation unit. The second laser beam is irradiated thereto through the second irradiation unit from the direction different from the irradiation direction of the first laser beam. In this manner, the position of the liquid is controlled by the second laser beam and the liquid is dried by the first laser beam. As a result, the liquid can be dried at a desired position on the substrate, enabling formation of a pattern made of the pattern formation material with high definition and high precision.

The pattern formation apparatus according to the third aspect, preferably, further includes a stage for mounting the substrate thereon to move and guide the substrate in a scanning direction and a carriage moving in a sub-scanning direction perpendicular to the scanning direction in which the stage moves, the carriage including the liquid droplet discharging head and the first and the second irradiation units.

In the above apparatus, since the first and the second irradiation units are integrally included in the carriage, relative positions of both units can be fixed through the carriage. Thus, relative irradiation positions of the first and the second laser beams irradiated can be maintained with respect to the liquid. As a result, the laser beams from the both irradiation units can be irradiated to the liquid more surely at a desired position.

Preferably, in the above pattern formation apparatus, the first and the second irradiation units are disposed so as to sandwich the liquid droplet discharging head therebetween.

In this apparatus, since the first and the second irradiation units sandwich the liquid droplet discharging head therebetween, the first and the second laser beams can be irradiated to the liquid from mutually opposing directions in such a simple structure.

In the pattern formation apparatus according to the third aspect, preferably, the liquid containing the pattern formation material is a metallic ink that contains metal microparticles dispersed therein, and the substrate is a low-temperature co-fired ceramic substrate.

In the pattern formation apparatus according to the third aspect, the first and the second laser beams from the first and the second irradiation units are irradiated to the metallic ink placed on the low-temperature co-fired ceramic substrate. This can improve efficiency in drying of the metallic ink, so that formation failure of a pattern made of the metallic ink can be reduced.

In the pattern formation apparatus according to the third aspect, preferably, the first laser beam from the first laser output unit has a wavelength with a high rate of absorption into the liquid, whereas the second laser beam from the second laser output unit has a wavelength with a low rate of absorption into the liquid.

In this apparatus, since the first laser beam is highly absorbed by the liquid, motion energy of photons is concentrated on the pattern formation material on the surface portion of the liquid. Then, microparticles of the pattern formation material liquid collide with one another and thereby heat is generated, enabling drying of the liquid. Meanwhile, since the second laser beam is poorly absorbed by the liquid, the motion energy of the photons is transmitted to microparticles of the pattern formation material liquid of the entire inside of the liquid. The individual microparticles thereof cannot obtain a large amount of the motion energy occurring in the process where heat is generated by the collisions among the material liquid microparticles. The microparticles perform a motion for causing a translational motion of the liquid in a direction along a proceeding direction of the second laser beam. Consequently, the second laser beam can freely control the position of the liquid by changing its irradiation direction and power intensity.

Furthermore, a liquid dryer according to a fourth aspect of the invention includes a substrate for placing a liquid containing a pattern formation material thereon, a first laser output unit for emitting a first laser beam to dry the liquid on the substrate, a second laser output unit for emitting a second laser beam to move the liquid thereon, a first irradiation unit for irradiating the first laser beam from the first laser output unit to the liquid thereon, and a second irradiation unit for irradiating the second laser beam from the second laser output unit to the liquid thereon from a direction different from an irradiation direction of the first laser beam.

In the above liquid dryer, the first laser beam is irradiated to the liquid on the substrate through the first irradiation unit, and the second laser beam is irradiated thereto on the substrate through the second irradiation unit from the direction different from the irradiation direction of the first laser beam. In this manner, the second laser beam freely controls the position of the liquid on the substrate and the first laser beam dries the liquid thereon. Thus, the liquid can be dried at a desired position on the substrate, which enables formation of a pattern made of the pattern formation material with high definition and high precision.

The liquid dryer according to the fourth aspect, preferably, further includes a stage for mounting the substrate thereon to move and guide the substrate in a scanning direction and a carriage moving in a sub-scanning direction perpendicular to the scanning direction in which the stage moves, the carriage including the first and the second irradiation units.

In the above liquid dryer, since the first and the second irradiation units are integrally included in the carriage, relative positions of both units can be fixed through the carriage. Thus, relative irradiation positions of the first and the second laser beams to be irradiated can be maintained with respect to the liquid on the substrate. As a result, the laser beams from the first and the second irradiation units can be more surely irradiated to the liquid at a desired position.

### BRIEF DESCRIPTION OF THE DRAWINGS

The invention will be described with reference to the accompanying drawings, wherein like numbers reference like elements.

FIG. 1 is a perspective view of a circuit module.

FIG. 2 is an illustration showing a method for manufacturing the circuit module.

FIG. 3 is a perspective view of a liquid droplet discharging apparatus.

FIG. 4 is a perspective view of a liquid droplet discharging head.

FIG. 5 is a side view of the liquid droplet discharging head.

FIG. 6 is an illustration showing the liquid droplet discharging head and semiconductor lasers.

FIG. 7A is an illustration showing a drying mechanism of a liquid droplet.

FIG. 7B is an illustration showing a moving mechanism of the liquid droplet.

FIG. 8 is an electrical block circuit diagram illustrating an electrical configuration of the liquid droplet discharging apparatus.

### DESCRIPTION OF AN EXEMPLARY EMBODIMENT

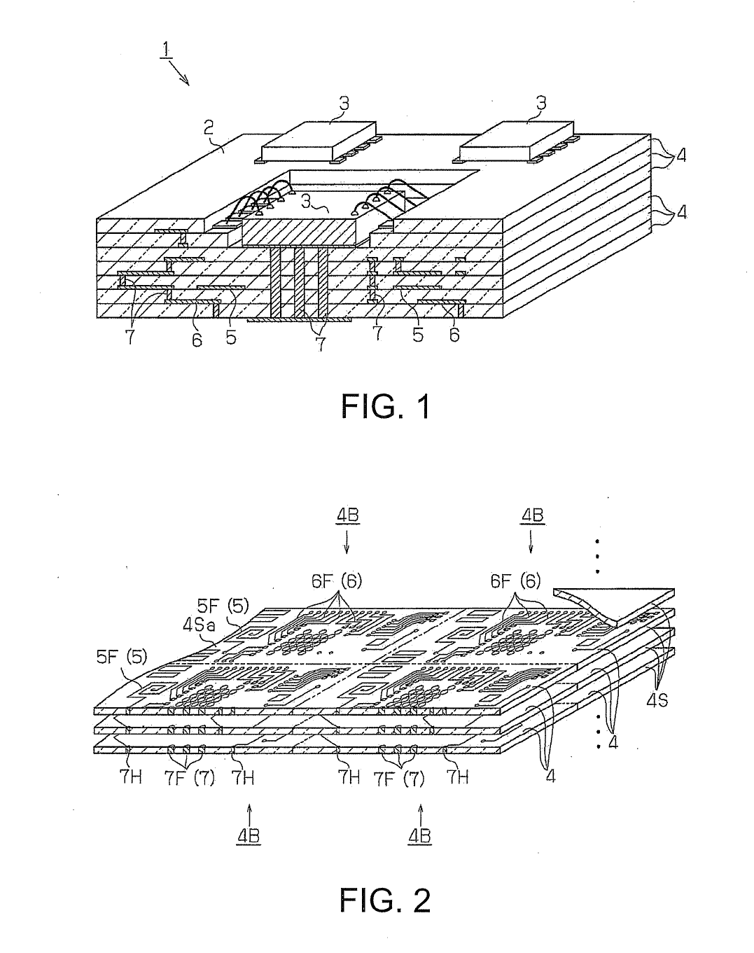

Hereinafter, an embodiment of the invention will be described with reference to FIGS. 1 to 8. First will be described a circuit module 1 produced by applying a pattern formation method according to the embodiment.

In FIG. 1, the circuit module 1 includes a plate-shaped multilayer LTCC substrate 2 and a plurality of semiconductor chips 3 connected to an upper side of the substrate 2 by wire bonding or flip-chip bonding.

The multilayer LTCC substrate 2 is formed by laminating a plurality of sheet-shaped low temperature co-fired ceramic substrates (hereinafter referred to simply as insulating layers 4). Each of the insulating layers 4 is a sintered body made of a glass ceramic material (e.g. a mixture of a glass component such as alkali borosilicate glass and a ceramic component such as aluminum) and has a thickness of a few hundred μm.

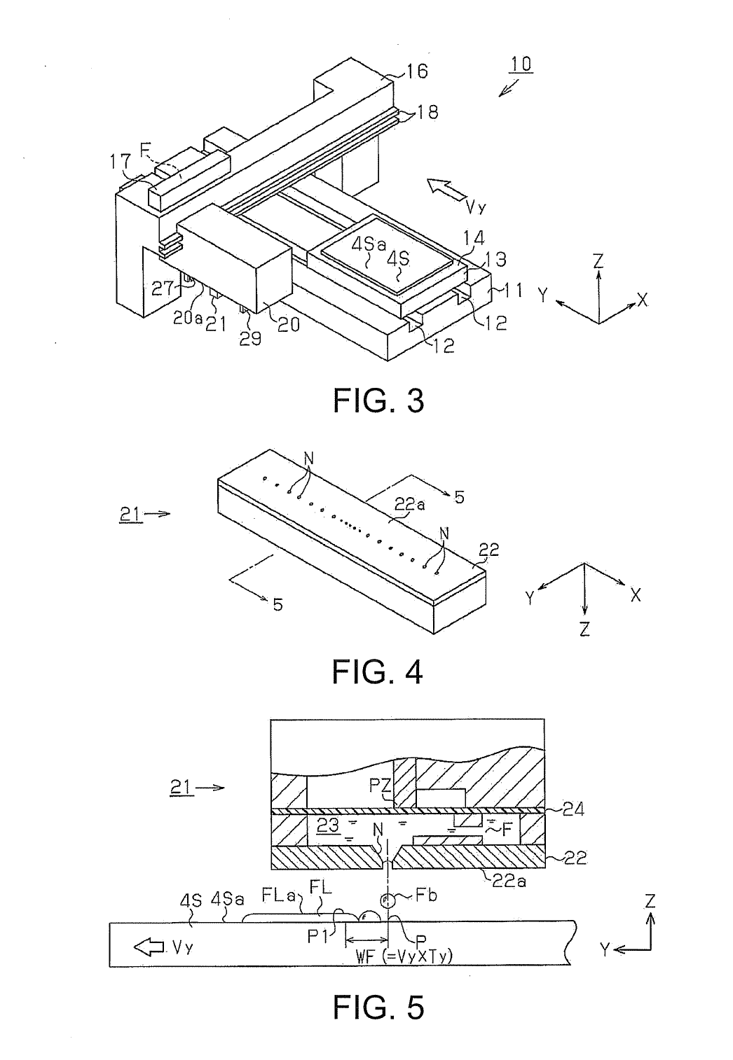

Among the insulating layers 4 are formed various circuit elements 5 such as a resistance element, a capacitance element, and a coil element, along with a plurality of internal wirings 6 as metallic wirings for electrically connecting the circuit elements 5 to each other. The circuit elements 5 and the internal wirings 6 each are a sintered body made of metal microparticles such as silver or silver alloy microparticles, and are provided by using a liquid droplet discharging apparatus 10 (see FIG. 3) according to the embodiment of the invention. Inside each insulating layer 4 are formed via-wirings 7 having a stack via structure or a thermal via structure to electrically connect the circuit elements 5 to the internal wirings 6 among the layers. Like the circuit elements 5 and the internal wirings 6, via-wirings 7 each are a sintered body made of metallic powder microparticles of silver, silver alloy or the like.

Next will be described a method for manufacturing the multilayer LTCC substrate 2 with reference to FIG. 2.

In FIG. 2, first, punching or laser processing is performed on each of green sheets 4S as a substrate from which each insulating layer 4 is cut out, whereby via-holes 7H are punched into the sheet. Then, screen printing using a metallic paste is performed on the green sheets 4S a plurality of times to fill the via-holes 7H with the metallic paste, thereby forming via-patterns 7F made of the metallic paste. Thereafter, inkjet printing is performed on an upper surface (hereinafter referred to simply as a pattern-formed surface 4Sa) of each green sheet 4S by using a metallic ink F (an aqueous silver ink in the embodiment), which is a pattern formation material prepared by dispersing metal nano/microparticles in an aqueous solvent.

Specifically, liquid droplets Fb of the metallic ink F (see FIG. 5) are discharged on the pattern formation surface 4Sa, which is a region for forming the circuit elements 5 and the internal wirings 6 (hereinafter referred to simply as a pattern formation region). The liquid droplets Fb land on the pattern formation region and are dried thereon. The discharging and drying operations are repeated to draw element patterns 5F and wiring patterns 6F corresponding to the pattern formation region. In this case, the liquid droplets Fb landed on the region are dried by irradiating laser beams thereto.

After formation of the element patterns 5F, the wiring patterns 6F, and the via-patterns 7F on the green sheets 4S, the sheets are collectively laminated together. Next, each region corresponding to the multilayer LTCC substrate 2 is cut out as a laminated structure 4B to be fired. In other words, the green sheets 4S with the element patterns 5F, the wiring patterns 6F, and via-patterns 7F are collectively laminated together and simultaneously fired. As a result, there can be obtained the multilayer LTCC substrate 2 including the insulating layers 4 with the circuit elements 5, the internal wirings 6, and the via-wirings 7.

Next, a description will be given of the liquid droplet discharging apparatus 10 used for drawing the element patterns 5F and the wiring patterns 6F by referring to FIG. 3. FIG. 3 is an entire perspective view of the liquid droplet discharging apparatus 10.

In FIG. 3, the liquid droplet discharging apparatus 10 includes a base 11 having a rectangular parallelepiped shape. On an upper surface of the base 11 are formed a pair of guiding grooves 12 extending in a longitudinal direction (a Y-arrow direction) thereof. On the guiding grooves 12 is disposed a stage 13 moving in the Y-arrow direction and a counter-Y-arrow direction along the grooves. On an upper surface of the stage 13 is formed a mounting board 14 for mounting each of the green sheets 4S thereon such that the pattern formation surface 4Sa faces upward. The mounting board 14 fixes a position of the mounted green sheet 4S relatively with respect to the stage 13 to carry the sheet in the Y-arrow direction and the counter-Y-arrow direction. In the present embodiment, in FIG. 3, the Y-arrow direction is defined as a scanning direction. Additionally, a velocity for carrying the green sheet 4S in the scanning direction is defined as a scanning velocity Vy.

On the base 11, a gate-shaped guiding member 16 is bridged on opposite sides of an X-arrow direction orthogonal to the scanning direction of the base 11 so as to straddle the base 11. On an upper surface of the guiding member 16 is disposed an ink tank 17 extending in the X-arrow direction. The ink tank 17 stores the metallic ink F as a liquid to supply it, at a predetermined pressure, to a liquid droplet discharging head (hereinafter referred to simply as a discharging head) 21 disposed below.

In this embodiment, for example, the metallic ink F may be a dispersive metallic ink prepared by dispersing metallic microparticles having a diameter of a few nm in a solvent.

The metallic microparticles contained in the metallic ink F may be made of, for example, gold (Au), silver (Ag), copper (Cu), aluminum (Al), palladium (Pd), manganese (Mn), titanium (Ti), tantalum (Ta), nickel (Ni), an oxide of any thereof, or a superconductor material. Preferably, the metallic microparticles have a diameter of 1 to 0.1 μm. If the diameter is larger than 0.1 μm, any discharging nozzle N of the discharging head 21 can be clogged. Additionally, if the diameter is smaller than 1 nm, a volume ratio of a dispersant to the metallic microparticles becomes greater, thereby excessively increasing the ratio of an organic substance in an obtained film.

The dispersion solvent is not specifically limited as long as the above metallic microparticles can be dispersed therein and there occurs no cohesion of the microparticles. Examples of the solvent include an aqueous solvent, alcohols such as methanol, ethanol, propanol, and butanol, hydrocarbon compounds such as n-heptane, n-octane, decane, dodecane, tetradecane, toluene, xylene, cymene, durren, indene, dipentene, tetrahydronaphthalene, decahydronaphthalene, and cyclohexylbenzene, polyols such as ethyleneglycol, diethyleneglycol, triethyleneglycol, glycerine, and 1,3-propanediol, ether compounds such as polyethylene glycol, ethyleneglycoldimethylether, ethyleneglycoldiethylether, ethyleneglycolmethylethylether, diethyleneglycoldimethylether, diethyleneglycoldiethylether, diethyleneglycolmethylethylether, 1,2-dimethoxyethane, bis(2-methoxyethyl) ether and p-dioxane, and polar compounds such as propylenecarbonate, gamma-butyrolactone, N-methyl-2-pyrrolidone, dimethylformamide, dimethylsulfoxide, cyclohexanone, and ethyl lactate. Among them, it is preferable to use aqueous solvents, alcohols, hydrocarbon compounds, and ether compounds because of the dispersibility of microparticles, the stability of a dispersion solution, and easy applicability to the liquid droplet discharging method. Particularly preferable dispersion solvents may be aqueous solvents and hydrocarbon compounds.

For example, the metallic ink F may be prepared by dispersing silver (Ag) microparticles in an aqueous solvent composed of 40% of water (boiling point: 100° C.), 40% of ethylene glycol (boiling point: 198° C.), and 30% of polyethylene glycol #1000 (decomposition temperature: 168° C.). Alternatively, the metallic ink F may be a liquid composed of metallic microparticles (those of Au, Ag, Ni, or Mn) dispersed in a solvent of tetradecane (boiling point: 253° C.).

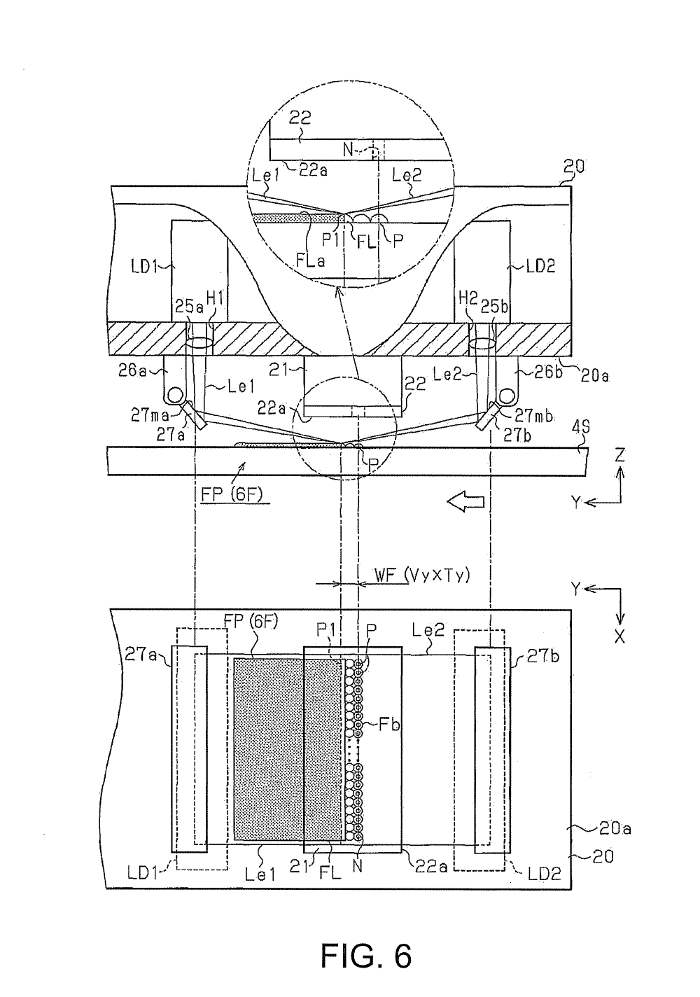

On a side of the guiding member 16 facing the counter-Y-arrow direction are provided a pair of upper and lower guiding rails 18, which extend in the X-arrow direction over an approximately entire width of the direction. The pair of guiding rails 18 have a carriage 20 mounted thereon. The carriage 20 moves (is fed) in the X-arrow direction and a counter-X-arrow direction along the guiding rails 18. On a bottom surface 20a of the carriage 20, the discharging head 21 is mounted at an approximately center of the scanning direction thereof. FIG. 4 is a perspective view of the discharging head 21 when viewed from a lower side thereof (from a side thereof facing the green sheet 4S). FIG. 5 is a sectional view thereof taken along a line 5-5 of FIG. 4, and FIG. 6 is an illustration of the carriage 20.

In FIG. 4, the discharging head 21 is formed in a rectangular parallelepiped shape extending in the X-arrow direction. On the lower side of the discharging head 21 (the side thereof facing the green sheet 4S: an upper side thereof in FIG. 4), there is disposed a nozzle plate 22, which has a plate-like shape extending in the X-arrow direction. On a lower surface of the nozzle plate 22 (an upper surface thereof in FIG. 4) is provided a nozzle-formed surface 22a, which is provided approximately in parallel to the pattern-formed surface 4Sa of the green sheet 4S. When the green sheet 4S is positioned immediately below the discharging head 21, a distance (a platen gap) is maintained between the nozzle-formed surface 22a and the pattern-formed surface 4Sa by a predetermined amount (300 μm in the present embodiment). On the nozzle-formed surface 22a are aligned a plurality of nozzles N in the X-arrow direction. The nozzles N each are formed so as to penetrate through the nozzle-formed surface 22a in a normal direction thereof.

In FIG. 5, at an upper side of each nozzle N is formed a cavity 23 communicating with each ink tank 17. The cavity 23 supplies the metallic ink F from the ink tank 17 to the nozzle N corresponding thereto. To an upper side of the cavity 23 is attached a vibration plate 24, which vibrates up and down to increase or decrease a capacity of the cavity 23. On an upper side of the vibration plate 24 are disposed a plurality of piezoelectric elements PZ corresponding to the nozzles N. Each of the piezoelectric elements PZ shrinks and extends up and down to allow a region of the vibration plate 24 corresponding thereto to vibrate up and down so as to discharge the metallic ink F as a liquid droplet Fb having a predetermined amount (10 pl in the present embodiment) from the corresponding nozzle N. The liquid droplets Fb fly in a counter-Z-arrow direction of the corresponding nozzles N to form a mutually facing droplet mark pattern. In this case, a position corresponding to the counter-Z-arrow direction of each nozzle N, namely, a landing position of each liquid droplet Fb is defined as a landing position P.

The landed liquid droplet Fb spreads in a wetting manner along the pattern-formed surface 4Sa during a time in which the green sheet 4S is scanned in the scanning direction, and then joins with a previously landed liquid droplet Fb. The joined liquid droplets Fb form a liquid film FL extending in the scanning direction. The liquid film FL has a liquid surface FLa approximately in parallel to the pattern-formed surface 4Sa over the entire top surface of the film.

In the present embodiment, a time required for the landed droplets Fb to form the liquid film FL is defined as an irradiation standby time Ty. Additionally, a distance where the liquid droplets Fb are scanned during the irradiation standby time Ty is defined as an irradiation standby distance WF (=scanning velocity Vy×irradiation standby time Ty).

Furthermore, in the present embodiment, a position on the liquid surface FLa, which is a position shifted away from each landing position P by the irradiation standby distance WF in the scanning direction, is defined as an irradiation position P1.

In FIG. 6, on the bottom surface 20a of the carriage 20, there is formed a first emission hole H1 in the scanning direction of the discharging head 21 (the Y-arrow direction). The hole H1 penetrates through to an inside of the carriage 20. The first emission hole H1 has an X-arrow direction width approximately equal to that of the discharging head 21. At an upper side of the first emission hole H1 is disposed a first semiconductor laser LD1 as a first laser output unit.

The first semiconductor laser LD1 downwardly emits a collimated laser beam having a ribbon shape extending over an approximately entire width in the X-arrow direction of the first emission hole H1. The laser beam emitted by the first semiconductor laser LD1 has a wavelength within a range with a high rate of absorption into the metallic ink F. In other words, the first semiconductor laser LD1 emits a laser beam that is irradiated to the liquid film FL to dry the film.

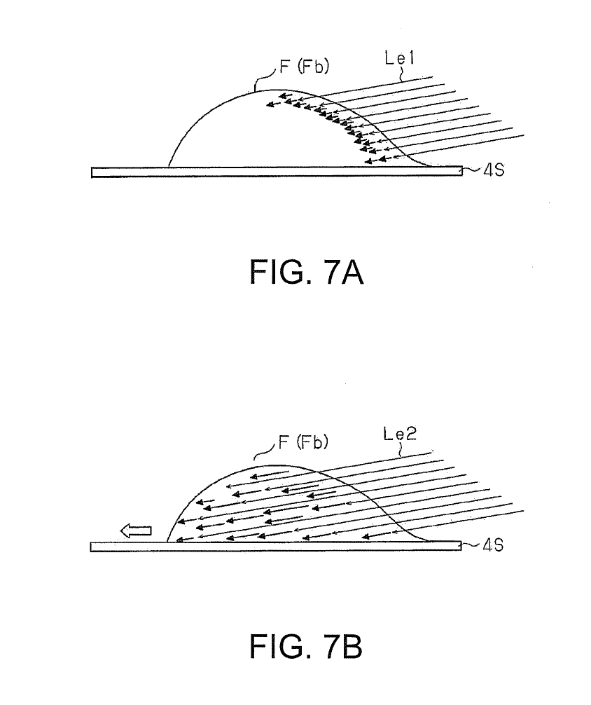

Specifically, at the wavelength highly absorbed by the metallic ink F, the first semiconductor laser LD1 irradiates a laser beam (a first irradiation beam Le1) to the metallic ink F. Then, as shown in FIG. 7A, the laser beam therefrom is absorbed into the surface of the liquid droplet Fb of the metallic ink F. Thus, photons do not reach an inside of the liquid droplet Fb and, therefore, their motion energy is transmitted only to the metallic microparticles at the surface of the droplet. In other words, since the metallic microparticles located at the surface portion of the liquid droplet Fb intensively receive the motion energy of the photons, the individual metal microparticles obtain a large amount of the motion energy, thereby causing collisions among them. Then, the collisions generate heat, which dries the liquid droplet Fb.

Meanwhile, in the case of the laser beam poorly absorbed by the metallic ink F, the beam reaches the inside of the liquid droplet Fb, so that the motion energy of photons is transmitted to the metallic microparticles of the entire inside of the droplet. As a result, the individual metallic microparticles move in the laser beam irradiation direction, causing the position of the metallic ink F to be shifted.

The absorption rate of the laser beam depends on a density of the metallic ink F. The following expressions are obtained when the density is C, an extinction coefficient is ε, a length of the liquid droplet Fb is L, a transmittance is T, and an extinction is E.

T=10^{-εCL} [Expression 1]

E=−log₁₀T [Expression 2]

In the above case, when an expression C≈E/εL holds, the photons travel through the entire liquid droplet to cause movement of the liquid droplet Fb. Additionally, when an expression C >>E/εL holds, the photons reach only the surface of the liquid droplet Fb to cause drying thereof. In the case of C<<E/εL, the photons pass through the liquid droplet to cause no change.

In the present embodiment, an experiment or the like is conducted in advance to obtain the wavelength of the laser beam from the first semiconductor laser LD1, which is within the range highly absorbed by the metallic ink F and suitable to drying of the droplet. Consequently, the present embodiment uses a beam wavelength of 800 nm for the laser LD1.

Inside the first emission hole H1 is disposed a first cylindrical lens 25a included in the first irradiation unit. The first cylindrical lens 25a has a curvature only in the Y-arrow direction. A surface width thereof in the X-arrow direction is equal to the width of the discharging head 21 in the X-arrow direction. When the first semiconductor laser LD1 emits a laser beam, the first cylindrical lens 25a converges only a light component of the laser beam in the scanning direction to downwardly emit it as the first irradiation beam Le1.

At a lower side of the first emission hole H1, there are disposed a first mirror stage 26a and a first reflection mirror 27a that are included in the first irradiation unit. The first mirror stage 26a is extended down below the carriage 20 and the first reflection mirror 27a is rotatably supported by the first mirror stage 26a. The mirror stage 26a rotatably supports the reflection mirror 27a around a rotational axis along the X-arrow direction.

The first reflection mirror 27a is a plane mirror having a reflective surface 27ma facing the first cylindrical lens 25a. An X-arrow direction width of the reflective surface 27ma is equal to that of the discharging head 21. When the first semiconductor laser LD1 emits a laser beam, the first reflection mirror 27a reflects the first irradiation beam Le1 from the first cylindrical lens 25a along an approximately tangential direction (an approximately counter-scanning direction) of the pattern-formed surface 4Sa. The first reflection mirror 27a irradiates such that the first irradiation beam Le1 reflected by the mirror is converged to all the irradiation positions P1.

The ribbon-shaped first irradiation beam Le1 irradiated to the irradiation positions P1 has the wavelength within the range highly absorbed by the metallic ink F. Thus, the first irradiation beam Le1 permeates the liquid surface FLa and is absorbed into the liquid film FL to start drying of the film. Specifically, at the wavelength highly absorbed by the ink, momentum of the first irradiation beam Le1 (photons) is transmitted to the metallic microparticles located near the surface of the liquid film FL. Thus, there occur collisions among the metallic microparticles near the surface thereof, which generates heat to start drying of the liquid droplet.

In FIG. 6, on the bottom surface 20a of the carriage 20, there is formed a second emission hole H2 in the counter-scanning direction (the counter-Y-arrow direction) of the discharging head 21. The second emission hole H2 penetrates through to the inside of the carriage 20. The second emission hole H2 has an X-arrow direction width approximately equal to that of the discharging head 21. At an upper side of the second emission hole H2 is disposed a second semiconductor laser LD2 as a second laser output unit.

The second semiconductor laser LD2 downwardly emits a collimated laser beam having a ribbon shape extending over an approximately entire width in the X-arrow direction of the second emission hole H2. A wavelength of the laser beam emitted by the second semiconductor laser LD2 is set within a range with a low rate of absorption into the metallic ink F.

Specifically, at the wavelength poorly absorbed by the metallic ink F, the second semiconductor laser LD2 irradiates a laser beam (a second irradiation beam Le2) to the metallic ink F. In this case, as shown in FIG. 7B, the laser beam from the second semiconductor laser LD2 reaches the inside of the liquid droplet Fb of the metallic ink F, as described above. Thereby, the motion energy of photons is transmitted to all the metallic microparticles of the entire inside thereof. In other words, since the motion energy is uniformly transmitted to the metallic microparticles of the entire inside of the liquid droplet Fb, the individual metal microparticles cannot obtain a large amount of the motion energy occurring in the process where heat is generated by the collisions among the microparticles. Instead, the metallic microparticles perform a motion for causing a translational motion of the liquid droplet Fb in a direction along a proceeding direction of the second irradiation beam Le2.

In the present embodiment, an experiment or the like is conducted in advance to obtain the wavelength of a laser beam from the second semiconductor laser LD2, which is a wavelength within the range poorly absorbed by the metallic ink F and suitable to cause the translational motion. As a result, the embodiment uses a wavelength of 1000 nm for the laser beam Le2.

The second semiconductor laser LD2 of the embodiment irradiates a laser beam to the liquid film FL to shift the position of the film. In other words, in this case, when the liquid film FL is dried by the laser beam (the first irradiation beam Le1) of the first semiconductor laser LD1 at the irradiation position P1, the second semiconductor laser LD2 flattens a portion of the liquid film FL where the first irradiation beam Le1 is input and retains a portion of the liquid film FL dried at the irradiation position P1 so as not to move in the irradiation direction of the first irradiation beam Le1 during a drying process by the laser beam Le1.

Inside the second emission hole H2 is disposed a second cylindrical lens 25b included in a second irradiation unit. The second cylindrical lens 25b has a curvature only in the Y-arrow direction. A lens surface width of the second cylindrical lens 25b in the X-arrow direction is equal to the width of the discharging head 21 in the X-arrow direction. When the second semiconductor laser LD2 emits a laser beam, the second cylindrical lens 25b converges only a light component of the laser beam in the scanning direction to downwardly emit it as the second irradiation beam Le2.

At a lower side of the second emission hole H2 are disposed a second mirror stage 26b and a second reflection mirror 27b that are included in the second irradiation unit. The second mirror stage 26b is extended down below the carriage 20 and the second reflection mirror 27b is rotatably supported by the second mirror stage 26b. The mirror stage 26b rotatably supports the reflection mirror 27b around a rotational axis along the X-arrow direction.

The second reflection mirror 27b is a plane mirror having a reflective surface 27mb facing the second cylindrical lens 25b. A width of the reflective surface 27mb in the X-arrow direction is formed to be equal to the width of the discharging head 21 in the X-arrow direction. When the second semiconductor laser LD2 emits a laser beam, the second reflection mirror 27b reflects the second irradiation beam Le2 from the second cylindrical lens 25b along the approximately tangential direction (the approximately counter-scanning direction) of the pattern-formed surface 4Sa. The second reflection mirror 27b irradiates such that the second irradiation beam Le2 reflected by the mirror is converged to all the irradiation positions P1.

The ribbon-shaped second irradiation beam Le2 irradiated to the irradiation positions P1 has the wavelength within the range poorly absorbed by the metallic ink F. Thus, the second irradiation beam Le2 provides a motion for moving the liquid film FL located at the irradiation positions P1 in a direction along a proceeding direction of the second irradiation beam Le2. Consequently, the ribbon-shaped second irradiation beam Le2 flattens a portion of the liquid film (the irradiation positions P1) where the beam Le2 is input.

Additionally, after irradiation of the first irradiation beam Le1, irradiation of the second irradiation beam Le2 restrains the liquid film FL (the liquid droplets Fb) from flowing (moving) in the irradiation direction of the first irradiation beam Le1 such that the droplets Fb are surely dried on the spot, thereby forming an adequately-dried layer pattern FP. Then, such layer patterns FP are laminated one by one, whereby the element patterns 5F and the wiring patterns 6F can be formed while enabling reduction of pattern formation failure.

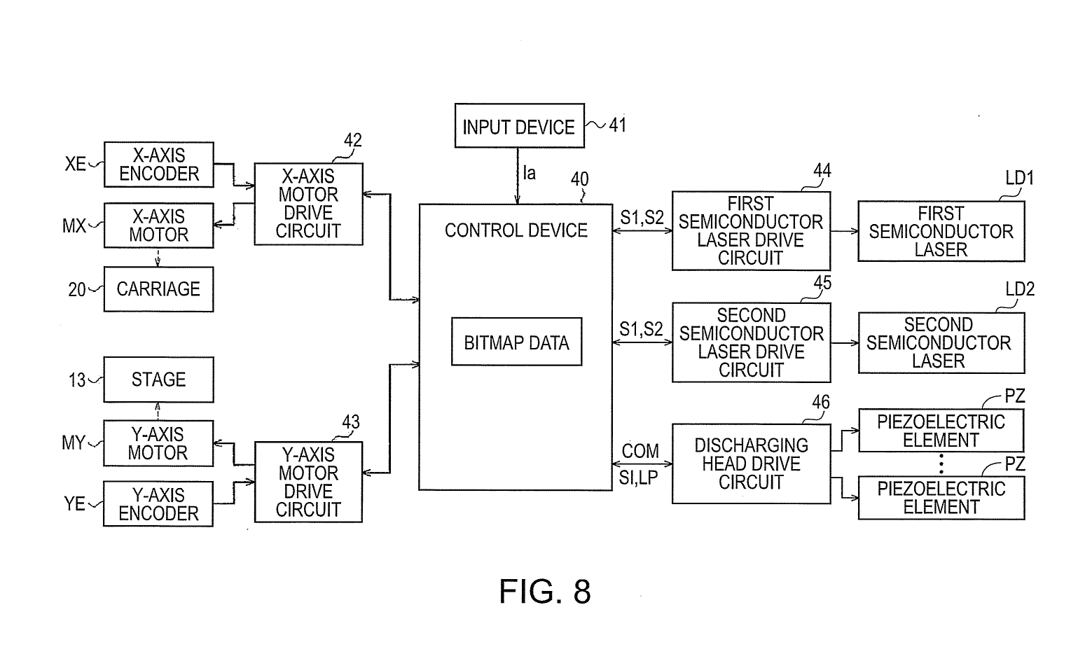

Next, an electrical configuration of the liquid discharging apparatus 10 structured as above will be described with reference to FIG. 8.

In FIG. 8, a control device 40 as a control unit includes a CPU, a ROM, and a RAM. In accordance with various data and control programs stored therein, the control device 40 moves the stage 13 and the carriage 20, as well as performs drive control of the first and the second semiconductor lasers LD1, LD2, and the individual piezoelectric elements PZ.

The control device 40 is connected to an input device 41 having operation switches such as a start switch and a stop switch. The input device 41 inputs data regarding positional coordinates of the pattern-formed region (the layer pattern FP) with respect to a drawing plane (the pattern-formed surface 4Sa) into the control device 40. The data is drawing information Ia having a predetermined form. The control device 40 receives the drawing information Ia from the input device 41 to produce bitmap data BMD.

The bitmap data BMD determines an ON or OFF state of the individual piezoelectric elements PZ in accordance with each bit value (0 or 1). The bitmap data BMD also determines whether the individual liquid droplets Fb should be discharged or not at individual positions on a drawing plane (the pattern-formed surface 4Sa) over which the discharging head 21 passes. In short, the bitmap data BMD serves to allow the liquid droplet Fb to be discharged at each target position determined on the pattern-formed region.

The control device 40 is connected to an X-axis motor drive circuit 42 to output a drive control signal corresponding to the X-axis motor drive circuit 42. In response to the drive control signal from the device, the X-axis motor drive circuit 42 rotates an X-axis motor MX in a forward or reverse direction to move the carriage 20. The X-axis motor drive circuit 42 is connected to an X-axis encoder XE to input a detection signal from the X-axis encoder XE. Based on the detection signal from the encoder, the X-axis motor drive circuit 42 generates a data signal regarding a moving direction and a moving amount of the carriage 20 (each landing position P) relative to the pattern-formed surface 4Sa to output the signal to the control device 40.

The control device 40 is also connected to a Y-axis motor drive circuit 43 to output a drive control signal corresponding to the Y-axis motor drive circuit 43. In response to the drive control signal from the device, the Y-axis motor drive circuit 43 rotates a Y-axis motor MY in a forward or reverse direction to move the stage 13. That is, through the Y-axis motor drive circuit 43, the control device 40 scans the stage 13 (pattern-formed surface 4Sa) by the irradiation standby distance WF during the irradiation standby time Ty, thereby forming the liquid film FL composed of the liquid droplets Fb located at the irradiation positions P1.

The Y-axis motor drive circuit 43 is connected to a Y-axis encoder YE to input a detection signal to the circuit from the encoder. Based on the detection signal from the Y-axis encoder YE, the Y-axis motor drive circuit 43 generates a data signal regarding a moving direction and a moving amount of the stage 13 (the pattern-formed surface 4Sa) to output the signal to the control device 40. Based on the signal from the Y-axis motor drive circuit 43, the control device 40 calculates a relative position of the landing position P with respect to the pattern-formed surface 4Sa and outputs a discharging timing signal LP every time a target position matches the corresponding landing position P.

The control device 40 is also connected to a first semiconductor laser drive circuit 44. The control device 40 outputs a drawing start signal S1 to the circuit when starting a drawing operation and outputs a drawing end signal S2 thereto when ending the drawing operation. Based on the drawing start signal S1 from the control device 40, the first semiconductor laser drive circuit 44 allows the first semiconductor laser LD1 to emit a laser beam. Additionally, based on the drawing end signal S2 therefrom, the drive circuit 44 allows the laser LD1 to stop emission of the laser beam. In short, through the first semiconductor laser drive circuit 44, the control device 40 performs the drive control of the first semiconductor laser LD1 during a drawing operation to allow the laser to irradiate a laser beam.

Additionally, the control device 40 is connected to a second semiconductor laser drive circuit 45 to output the drawing start signal S1 to the circuit 45 when starting the drawing operation and to output the drawing end signal S2 thereto when ending the drawing operation. Based on the drawing start signal S1 from the control device 40, the second semiconductor laser drive circuit 45 allows the second semiconductor laser LD2 to emit a laser beam, and based on the drawing end signal S2 therefrom, the circuit 45 allows the laser LD2 to stop emission of the laser beam. In short, through the second semiconductor laser drive circuit 45, the control device 40 performs drive control of the second semiconductor laser LD2 during the drawing operation to allow it to irradiate the laser beam.

Furthermore, the control device 40 is connected to a discharging head drive circuit 46. The control device 40 outputs a piezoelectric-element drive voltage COM for driving each piezoelectric element PZ to the circuit 46 in synch with the discharging timing signal LP. Additionally, based on the bitmap data BMD, the control device 40 generates a discharging control signal S1 synchronized with a predetermined clock signal to serially transmit it to the discharging head drive circuit 46. The circuit 46 sequentially performs serial/parallel conversion of the discharging control signal S1 sent from the control device 40 so as to make the signal correspond to each piezoelectric element PZ. Then, every time the circuit 46 receives the discharging timing signal LP from the control device 40, the circuit 46 latches the discharging control signal S1 subjected to the serial/parallel conversion to supply the piezoelectric-element drive signal COM to each selected piezoelectric element PZ.

Next will be described a method for drawing the element patterns 5F and the wiring patterns 6F by using the liquid droplet discharging apparatus 10.

First, as shown in FIG. 3, the green sheet 4S is mounted on the stage 13 such that the pattern-formed surface 4Sa faces upward. In this case, the stage 13 with the green sheet 4S mounted thereon is positioned in the counter-scanning direction of the carriage 20.

In this situation, the input device 41 inputs the drawing information Ia to the control device 40. The control device 40 generates bitmap data BMD based on the drawing information Ia to store the data. Next, when the green sheet 4S is scanned, the control device 40 allows the X-axis motor drive circuit 42 to shift the position of the carriage 20 (the discharging head 21) to a predetermined position such that a target position passes the landing position P. After the position of the carriage 20 is shifted, the control device 40 allows the Y-axis motor drive circuit 43 to start scanning of the green sheet 4S.

After the start of the scanning thereof, the control device 40 outputs the discharging control signal S1 generated based on the bitmap data BMD to the discharging head drive circuit 45.

In addition, after the scanning thereof is started, the control device 40 outputs the discharging timing signal LP to the discharging head drive circuit 45, every time the target position matches the corresponding landing position P. Then, every time the control device 40 outputs the signal LP, the device allows the discharging head drive circuit 46 to select the nozzle N for discharging the liquid droplet Fb based on the discharging control signal S1 so as to discharge the liquid droplet Fb to the landing position P corresponding to the selected nozzle N, namely, to the target position. Each discharged liquid droplet Fb lands on the corresponding target position on the pattern-formed surface 4Sa. The liquid droplet Fb that landed on each target position is scanned by the irradiation standby distance WF in the scanning direction, and then joins with a previously landed liquid droplet Fb near the irradiation position P1, thereby forming the liquid film FL extending in the scanning direction.

In addition, after the scanning of the green sheet 4S is started, the control device 40 outputs the drawing start signal S1 to the first and the second semiconductor laser drive circuits 44 and 45 to allow the first and the second semiconductor lasers LD1 and LD2 to emit a laser beam.

After the semiconductor lasers LD1 and LD2 emit the laser beams, the reflection mirrors 27a and 27b, respectively, reflect the laser beams from the corresponding lasers LD1 and LD2. The laser beam from the laser LD1 is irradiated to the irradiation position P1, as the first irradiation beam Le1 in an approximately counter-scanning direction. Meanwhile, the laser beam from the laser LD2 is irradiated thereto, as the second irradiation beam Le2 in an approximately scanning direction.

Accordingly, the first irradiation beam Le1 starts to dry the liquid film FL at the irradiation positions P1, while the second irradiation beam Le2 is restraining the film from moving in the irradiation direction of the first irradiation beam Le1. As a result, the liquid film FL is surely dried on the spot while being flattened by the second irradiation beam Le2, so that an adequately-dried flat layer pattern FP can be formed. Next, such layer patterns FP are laminated together one by one to form the element patterns 5F and the wiring patterns 6F, whereby formation failure thereof can be reduced.

Now, advantageous effects of the present embodiment structured as above will be shown as follows:

1. The above embodiment employs the first semiconductor laser LD1 and the second semiconductor laser LD2. The laser LD1 emits the laser beam (the first irradiation beam Le1) having the wavelength within the range with the high rate of absorption into the metallic ink F to dry the liquid film FL. The laser LD2 emits the laser beam (the second irradiation beam Le2) having the wavelength within the range with the low rate of absorption thereinto to enable movement of the liquid film FL.

Then, the second irradiation beam Le2 moves the liquid film FL in the direction opposite to the irradiation direction of the first irradiation beam Le1 to restrain the liquid film FL from being moved by the beam Le1 for drying the film in the irradiation direction of the beam Le1. In short, the second irradiation beam Le2 controls the position of the film. Furthermore, the beam Le2 flattens the portion of the liquid film FL (the irradiation positions P1), to which the first irradiation beam Le1 is input.

Thus, when the liquid film FL is dried by the first irradiation beam Le1, the film is surely dried at the position while being flattened. As a result, there can be obtained adequately-dried layer patterns FP (the element patterns 5F and the wiring patterns 6F) with high definition and high precision.

In addition, each layer pattern FP can be flattened without rim rising of edges thereof. Furthermore, when the carriage 20 is fed to scan at a new position, the liquid film FL can be dried while flattening a boundary (joined portion) between the layer pattern FP dried at a precedent scanning and a newly provided liquid film FL.

2. In the above embodiment, the direction (the counter-Y-arrow direction when viewed from an upper side) of the first irradiation beam Le1 irradiated to the irradiation position P1 and the direction (the Y-arrow direction when viewed therefrom) of the second irradiation beam Le2 irradiated thereto are arranged to face each other when viewed from the upper side. Thus, a flow of the liquid film FL located at the irradiation position P1 can be easily controlled only by power intensity or emission timing of each of the irradiation beams Le1 and Le2.

3. In the above embodiment, the drive circuits 44 and 45, respectively, are independently provided for the first and the second semiconductor lasers LD1 and LD2, respectively. Accordingly, the power intensity and the emission timing thereof can be independently controlled. As a result, drying and positioning can be freely controlled, so that more appropriate drying can be accomplished. Therefore, the problem of pattern formation failure can be more surely solved.

4. In the above embodiment, the carriage 20 includes the first and the second semiconductor lasers LD1 and LD2, the first and the second cylindrical lens 25a and 25b, and the first and the second reflection mirrors 27a and 27b.

The above structure can maintain the relative positions of the first and the second irradiation beams Le1 and Le2 with respect to the landing position P (the liquid film FL) of the liquid droplet Fb. As a result, with higher reproducibility, the beams Le1 and Le2 can be irradiated to the irradiation position P1 of the liquid film FL. Thus, the element patterns 5F and the wiring patterns 6F can be stably kept in the dry state, so that formation failure thereof can be further reduced.

Additionally, the above embodiment may be modified as below:

In the embodiment, while the liquid film FL is sequentially being formed at a new place by discharging the liquid droplet Fb, the first and the second irradiation beams Le1 and Le2 are irradiated to dry each liquid film FL. Instead, the stage 13 and the carriage 20 may be moved relatively with each other to first form the liquid film FL as a predetermined pattern on the pattern-formed surface 4Sa of the green sheet 4S by using the discharging head 21. Then, again, the stage 13 and the carriage 20 may be moved relatively with each other to irradiate the irradiation beams Le1 and Le2 to the liquid film FL as the predetermined pattern formed on the above green sheet 4S so as to dry the liquid film FL.

In this case, for example, there is a method other than drying by simultaneous irradiation of the beams Le1 and Le2. First, after relatively moving the stage 13 and the carriage 20, only the second irradiation beam Le2 may be used to make even the liquid surface FLa of the liquid film FL as the predetermined pattern formed thereon so as to flatten the entire film. Next, the stage 13 and the carriage 20 may be moved relatively with each other to dry the film by using the first irradiation beam Le1.

The above embodiment employs the first irradiation beam Le1 having the wavelength of the range highly absorbed by the metallic ink F and the second irradiation beam Le2 having the wavelength within the range poorly absorbed by the ink to dry the liquid film FL. Alternatively, both the irradiation beams Le1 and Le2 may have the wavelength within the range poorly absorbed by the ink or may have the same wavelength, needless to say. In this case, the metallic ink F located at the irradiation position P1 of the liquid film FL receives motion energy given in mutually reversed directions by the irradiation beams Le1 and Le2. Thus, the liquid film FL (the liquid droplet Fb) does not move and the metallic microparticles receive a large amount of the motion energy, causing collisions among them. Then, the collisions generate heat, which dries the liquid film FL.

In such a case, the laser beam of one of the semiconductor lasers (for example, the second semiconductor laser LD2 in the above embodiment) may be divided into two beams by a half mirror or the like to irradiate the two beams to the liquid film FL so as to dry it. Alternatively, when the laser beam of one of the semiconductor lasers is irradiated to the film, its reflection beam may be reflected by a concave mirror and then again irradiated to the film.

In the above embodiment, the carriage 20 of the liquid droplet discharging apparatus 10 as the pattern formation apparatus of the embodiment includes the discharging head 21, the first and the second semiconductor lasers LD1, LD2 and the like. Instead of the structure, the liquid droplet discharging apparatus 10 may include a first carriage having only the discharging head 21 mounted thereon and a second carriage having the first and the second semiconductor lasers LD1, LD2, and the like mounted thereon.

Alternatively, the first and the second semiconductor lasers LD1, LD2, and the like as the units for drying the liquid film FL may not be included in the liquid droplet discharging apparatus 10. Instead, a specially designed laser dryer equipped with the lasers LD1 and LD2 may be provided to dry the film. In this case, the pattern formation apparatus includes the liquid droplet discharging apparatus 10 and the laser dryer.

In the above embodiment, the common first and the common second irradiation beams Le1 and Le2 are irradiated to the liquid film FL comprised of the plurality of liquid droplets Fb. Instead of this, for example, a laser beam from each of the first and the second semiconductor lasers LD1 and LD2 may be divided into a plurality of beams so as to correspond to each nozzle. Then, the first irradiation beams Le1 and the second irradiation beams Le2 may be irradiated to the liquid film FL (the individual liquid droplets Fb). Alternatively, the first and the second semiconductor lasers LD1 and LD2 may be provided in numbers equivalent to the number of the nozzles N to irradiate the first irradiation beams Le1 and the second irradiation beams Le2 to the liquid film FL (the individual liquid droplets Fb). In other words, the first and the second irradiation beams Le1 and Le2 corresponding to each liquid droplet Fb may be respectively irradiated to a region corresponding to the liquid droplet Fb.

In the above embodiment, the first and the second irradiation beams Le1 and Le2 are both ribbon-shaped (line-shaped) laser beams. However, the beams may be spot-shaped laser beams.

In the above embodiment, the nozzles N are arrayed in only a single line in the X-arrow direction. Instead, for example, only two arrays of the nozzles N may be placed in the X-arrow direction.

The above embodiment employs the first cylindrical lens 25a and the first reflection mirror 27a as concrete examples of the first irradiation unit, as well as employs the second cylindrical lens 25b and the second reflection mirror 27b as those of the second irradiation unit. Instead of them, as the first and the second irradiation units, only the first and the second cylindrical lenses 25a and 25b may be used to directly irradiate laser beams from the cylindrical lenses 25a and 25b to the liquid film FL. In other words, it is only necessary for the first and the second irradiation units to irradiate a laser beam emitted from a laser beam source onto a liquid droplet region.

In the above embodiment, based on the drawing information Ia, the bitmap data BMD is generated. Alternatively, the input device 41 may input bitmap data BMD generated in advance by an external device to the control device 40.

As a concrete example of the liquid droplet discharging head, the above embodiment employs the liquid droplet discharging head 21 of the piezoelectric element driving system. Alternatively, another example of the liquid droplet discharging head may be a discharging head of a resistance heating system or an electrostatic drive system.

In the above embodiment, the circuit elements 5 and the internal wirings 6 are formed by the inkjet method. Alternatively, only the relatively minute circuit elements 5 or internal wirings 6 may be formed by the foregoing inkjet method.

In the above embodiment, the metallic ink is employed as a concrete example of the pattern formation material. Instead of that, for example, the pattern formation material may be a liquid prepared by dispersing or dissolving an insulation film material or an organic material in a solvent. In this case, the organic material may be the one that is used for a resist, a protective film, a color filter of a display or the like, a transparent electrode (an ITO film), liquid crystal and an alignment film of a liquid crystal display, a light-emitting layer of an organic EL display, an electron transporting layer, a hole transporting layer, and the like. That is, as the pattern formation material, it is only necessary to use a material that can be dried by laser irradiation and can be formed into a solid-phase pattern.

In the above embodiment, as concrete examples of the pattern, there are provided the element patterns 5F and the wiring patterns 6F. Instead, the pattern may include various metallic wirings that are disposed in a liquid crystal display, an organic electroluminescence display, a field-effect display (e.g. FED or SED) equipped with a plane-shaped electron-emitting element, and the like. Alternatively, the pattern may be an identification code composed of a plurality of line patterns or dot patterns. In short, for the pattern, it only needs to be the one that can be formed of dried liquid droplets.

In the above embodiment, the irradiation timings of the first and the second irradiation beams Le1 and Le2 are not specifically limited. The irradiation timing of the beam Le2 may be appropriately changed in accordance with various pattern formations, as long as it is before the liquid film FL (the liquid droplets Fb) is dried and liquidity is lost.

In the above embodiment, the power intensity of each of the first and the second irradiation beams Le1 and Le2 is not specifically limited. In accordance with the dryness of the liquid film FL, the intensity thereof may be appropriately changed.

In the above embodiment, the irradiation positions P1 of the first and the second irradiation beams Le1 and Le2 are the same. However, the positions P1 thereof may be different. For example, the second beam Le2 may be irradiated to a part (position) that is to be irradiated by the beam Le2, whereby a part to be irradiated by the first beam Le1 (a position different from the position to be irradiated by the second beam Le2) may be retained at a desired position to be dried by the first beam Le1.

The entire disclosure of Japanese Patent Application No. 2007-032514, filed Feb. 13, 2007 is expressly incorporated by reference herein.

What is claimed is:

1. A pattern formation method, comprising:
placing a liquid containing a pattern formation material on a substrate; and
irradiating a plurality of laser beams to the liquid from different directions to dry the liquid so as to form a pattern made of the pattern formation material.

2. The pattern formation method according to claim 1, wherein the laser beams are irradiated to the liquid to control the position of the liquid, the laser beams being irradiated in directions and intensity distributions in which the laser beams mutually approximately offset at least a momentum of the liquid in a movable direction.

3. A pattern formation method, comprising:
placing a liquid containing a pattern formation material on a substrate; and
irradiating a first laser beam for drying the liquid and a second laser beam for controlling a position of the liquid so as to form a pattern made of the pattern formation material on the substrate.

4. The pattern formation method according to claim 3, wherein the first laser beam dries the liquid after the second laser beam controls the position of the liquid such that the liquid is located at a predetermined position.

5. The pattern formation method according to claim 3, wherein the first laser beam dries the liquid while the second laser beam is controlling the position of the liquid such that the liquid is moved to a predetermined position.

6. The pattern formation method according to claim 3, wherein the first laser beam dries the liquid while the second laser beam is retaining the liquid at a predetermined position.

7. The pattern formation method according to claim 3, wherein the first laser beam has a wavelength with a high rate of absorption into the liquid, whereas the second laser beam has a wavelength with a low rate of absorption thereinto.

8. A pattern formation apparatus, comprising:
a liquid droplet discharging head for discharging a liquid containing a pattern formation material;
a substrate for receiving a droplet of the liquid discharged from the head;
a first laser output unit for emitting a first laser beam to dry the liquid droplet on the substrate;
a second laser output unit for emitting a second laser beam to move the liquid droplet thereon;
a first irradiation unit for irradiating the first laser beam emitted from the first laser output unit to the liquid droplet thereon; and
a second irradiation unit for irradiating the second laser beam emitted from the second laser output unit to the liquid droplet thereon from a direction different from an irradiation direction of the first laser beam.

9. The pattern formation apparatus according to claim 8, further comprising a stage for mounting the substrate thereon to move and guide the substrate in a scanning direction and a carriage moving in a sub-scanning direction perpendicular to the scanning direction in which the stage moves, the carriage including the liquid droplet discharging head and the first and the second irradiation units.

10. The pattern formation apparatus according to claim 9, wherein the first and the second irradiation units are disposed so as to sandwich the liquid droplet discharging head therebetween.

11. The pattern formation apparatus according to claim 8, wherein the liquid containing the pattern formation material is a metallic ink that contains metal microparticles dispersed therein, and the substrate is a low-temperature co-fired ceramic substrate.

12. The pattern formation apparatus according to claim 8, wherein the first laser beam from the first laser output unit has a wavelength with a high rate of absorption into the liquid, whereas the second laser beam from the second laser output unit has a wavelength with a low rate of absorption into the liquid.

13. A liquid dryer, comprising:
a substrate for placing a liquid containing a pattern formation material thereon;
a first laser output unit for emitting a first laser beam to dry the liquid on the substrate;
a second laser output unit for emitting a second laser beam to move the liquid thereon;
a first irradiation unit for irradiating the first laser beam from the first laser output unit to the liquid thereon; and
a second irradiation unit for irradiating the second laser beam from the second laser output unit to the liquid thereon from a direction different from an irradiation direction of the first laser beam.

14. The liquid dryer according to claim 13, further comprising a stage for mounting the substrate thereon to move and guide the substrate in a scanning direction and a carriage moving in a sub-scanning direction perpendicular to the scanning direction in which the stage moves, the carriage including the first and the second irradiation units.
